(19) United States
(12) Patent Application Publication
(10) Pub. No.: US 2024/0311199 A1
(43) Pub. Date: Sep. 19, 2024

(54) SOFTWARE-DEFINED COMPUTE UNIT RESOURCE ALLOCATION MODE

(71) Applicant: Advanced MICRO DEVICES, INC., Santa Clara, CA (US)

(72) Inventors: Nicolai Haehnle, Munich (DE); Mark Leather, Santa Clara, CA (US); Brian Emberling, Palo Alto, CA (US); Michael John Bedy, Groton, MA (US); Daniel Schneider, Saratoga, CA (US)

(21) Appl. No.: 18/120,646

(22) Filed: Mar. 13, 2023

(51) Int. Cl. G06F 9/50; G06F 9/52

(52) U.S. Cl. CPC G06F 9/505; G06F 9/522

(57) ABSTRACT

A program code executing on a processing system includes one or more instructions each identifying a workload that includes a plurality of waves and each identifying resource allocations for the plurality of waves of the workgroup. In response to receiving an instruction identifying a workload and resource allocations for the plurality of waves of the workgroup, a processor allocates a first set of processing resources to a compute unit of the processor based on the resource allocations for the plurality of waves. The compute unit then performs operations for the workgroup using the allocated set of processing resources.

### BACKGROUND

To execute instructions for applications, processing systems include processors that have compute units configured to perform waves of operations for the applications. For performing these waves, each compute unit also includes processing resources such as vector registers and scratch memory that store data used in the performance of the waves. To launch multiple waves on a compute unit concurrently, fixed-function hardware of a processor allocates portions of the available processing resources to each wave to be launched on the compute unit. However, such fixed-function hardware only accounts for limited conditions when allocating the available processing resources to the waves, causing the fixed-function hardware to allocate more resources to a wave than is necessary. Such excess allocations lower the number of waves that may concurrently be launched on a compute unit, decreasing the efficiency and processing speed of the processing system.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system implementing software-defined compute unit resource allocation, in accordance with some embodiments.

FIG. 2 is a block diagram of an example processor core configured for software-defined compute unit resource allocation, in accordance with some embodiments.

FIG. 3 is a flow diagram of an example process for software-defined allocations of compute unit resources, in accordance with some embodiments.

FIG. 4 is a block diagram of an example program code for software-defined compute unit resource allocation, in accordance with some embodiments.

FIG. 5 is a flow diagram of an example method for software-defined compute unit resource allocation, in accordance with some embodiments.

### DETAILED DESCRIPTION

Applications (e.g., shader programs, raytracing programs) executing on a processing system generate program code indicating a plurality of work items (e.g., functions, operations) to be performed for the application. In embodiments, the processing system is configured to group such work items into one or more workgroups each including a respective number of waves (e.g., sub-groups of work items) to be performed. To execute these waves for a workgroup, the processing system includes an accelerated processing unit (APU) that has one or more compute units each including waveslots (e.g., portions of the compute unit) configured to perform a respective wave of a workgroup (e.g., perform one or more operations of a wave of the workgroup). Each compute unit further includes or is otherwise connected to compute unit resources (e.g., vector registers, local data shares, scratch memory) configured to store data used in the performance of the operations for a wave. To facilitate the concurrent performance of multiple waves on a compute unit, fixed-function hardware of the processing system allocates portions of the compute unit resources to each wave (e.g., to a waveslot of the compute unit assigned to the wave). However, due to the nature of the fixed-function hardware, only limited conditions are considered when allocating the compute unit resources to the waves. Due to this, the compute unit resources are not efficiently or effectively allocated to the waves. For example, under some conditions, the fixed-function hardware allocates more compute unit resources to a wave than are necessary to execute the wave or helpful for the performance of the wave, limiting the number of compute unit resources to be assigned to other waves and limiting the number of waves that are able to be executed concurrently by a compute unit.

To this end, the systems and techniques described herein are directed to software-defined compute unit resource allocation. To facilitate such software-defined compute unit resource allocation, an application (e.g., shader program, raytracing program) generates program code indicating a plurality of work items (e.g., functions, operations) grouped into one or more workgroups each having one or more waves (e.g., sub-groups of work items). Additionally, the application generates program code indicating resource allocations and synchronization data for the waves. Such resource allocations include data indicating one or more respective compute unit resources to allocate to each wave of a workgroup. For example, the resource allocations include data indicating one or more respective compute unit resources (e.g., a number of registers, an amount of a memory) to allocate to each wave, one or more compute unit resources (e.g., a number of registers, an amount of a memory) to share between the two or more waves (e.g., to allocate to two or more waves), or both. Further, such synchronization data indicates, for example, one or more workgroup barriers (e.g., thread barriers) for the waves of a workgroup, two or more waves of a workgroup to be performed concurrently, two or more waves of two or more workgroups to be performed concurrently, or any combination thereof. Workgroup barriers (e.g., thread barriers) cause one or more threads of a wave to pause until each thread of the wave has performed a predetermined operation, function, or both indicated by the barrier.

In response to receiving the program code (e.g., as commands, instructions, or both) including the workgroups, resource allocations, and synchronization data, a processor allocates compute unit resources to the waves of a workgroup (e.g., waveslots of a compute unit performing the waves) based on the received program code. For example, the processor allocates compute unit resources to the waves such that one or more conditions indicated in the resource allocations, synchronization data, or both are fulfilled. In this way, allocations of the compute unit resources to the waves are defined by the program code rather than the fixed-function hardware of the processing system. Due to the compute unit resource allocations being defined by the program code, additional conditions are considered when allocating the compute unit resources, increasing the number of available resources to allocate to the waves and increasing the number of concurrent waves launched on a compute unit. Additionally, because the compute unit resource allocations are defined by the program code, the processor is able to dynamically allocate available resources each time a workgroup is assigned (e.g., the processor is able to allocate resources each time a workgroup is assigned). As such, the processing speed and processing efficiency of the processing system are increased. Further, to allocate such resources, the processor is configured to modify one or more hardware registers of the processor based on the received program code (e.g., based on the resource allocations and synchronization data indicated in the program code). As an example, the processor updates a hardware register (e.g., base register) that stores a base address of one or more compute unit resources to allocate the compute unit resources to a wave. In this way, the processor allocates compute unit resources to the waves using the physical addresses (e.g., based on the base address) of the compute unit resources, limiting the need to recall, for example, a renaming table, and increasing the processing speed and efficiency of the processing system.

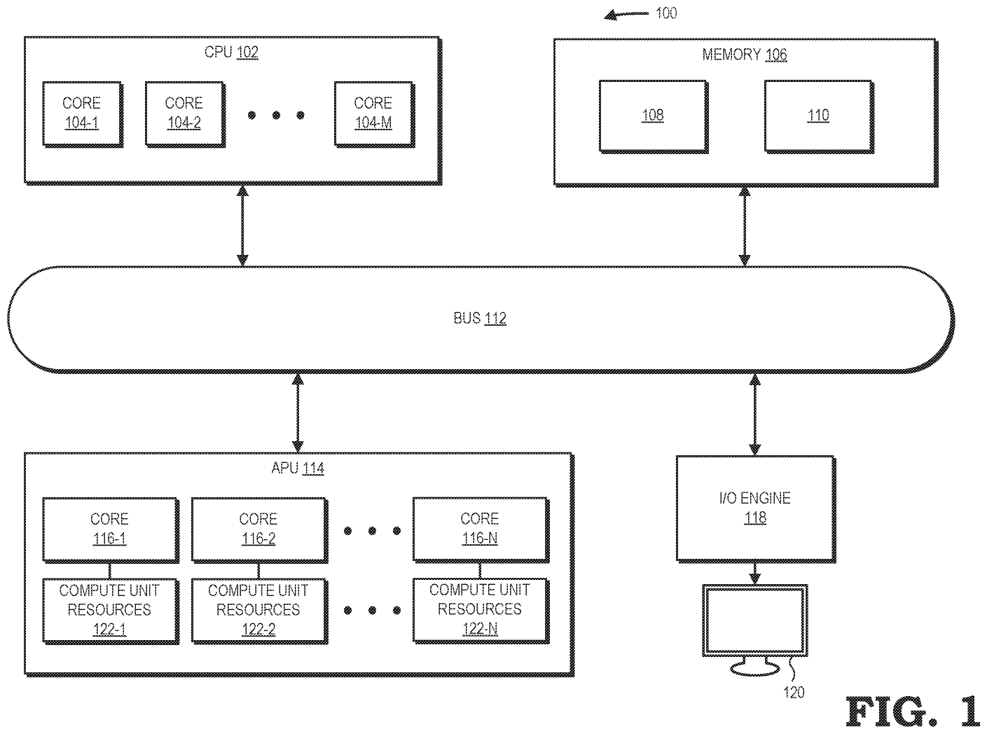

FIG. 1 is a block diagram of a processing system 100 implementing software-defined compute unit resource allocation, according to some embodiments. The processing system 100 includes or has access to a memory 106 or other storage component implemented using a non-transitory computer-readable medium, for example, a dynamic random-access memory (DRAM). However, in embodiments, the memory 106 is implemented using other types of memory including, for example, static random-access memory (SRAM), nonvolatile RAM, and the like. According to embodiments, the memory 106 includes an external memory implemented external to the processing units implemented in the processing system 100. The processing system 100 also includes a bus 112 to support communication between entities implemented in the processing system 100, such as the memory 106. Some embodiments of the processing system 100 include other buses, bridges, switches, routers, and the like, which are not shown in FIG. 1 in the interest of clarity.

The techniques described herein are, in different embodiments, employed at accelerated processing unit (APU) 114. APU 114 includes, for example, any of a variety of parallel processors, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The APU 114 renders images according to one or more applications 110 (e.g., shader programs) for presentation on a display 120. For example, the APU 114 renders objects (e.g., groups of primitives) according to one or more shader programs to produce values of pixels that are provided to the display 120, which uses the pixel values to display an image that represents the rendered objects. To render the objects, the APU 114 implements a plurality of processor cores 116-1 to 116-N that execute instructions concurrently or in parallel from, for example, one or more applications 110. For example, the APU 114 executes instructions from a shader program, raytracing program, graphics pipeline, or both using a plurality of processor cores 116 to render one or more objects. Though in the example implementation illustrated in FIG. 1, three processor cores (116-1, 116-2, 116-N) are presented representing an N number of cores, the number of processor cores 116 implemented in the APU 114 is a matter of design choice. As such, in other implementations, the APU 114 can include any number of processor cores 116. Some implementations of the APU 114 are used for general-purpose computing. The APU 114 executes instructions such as program code 108 (e.g., shader code, raytracing code) for one or more applications 110 (e.g., shader programs, raytracing programs) stored in the memory 106, and the APU 114 stores information in the memory 106 such as the results of the executed instruction.

In embodiments, the instructions indicated in program code 108 (e.g., shader code, raytracing code) from one or more applications 110 (e.g., shader programs, raytracing programs) define one or more work items (e.g., functions) each identifying, for example, one or more operations to be performed, a size of one or more workgroups (e.g., group of work items), or both. Additionally, in embodiments, processing system 100 groups such work items into one or more workgroups based on, for example, predetermined values, the types of operations identified in the work items, architecture of APU 114, availability of compute unit resources, or any combination thereof. To perform a workgroup (e.g., group of work items), one or more processor cores 116 of APU 114 operate as one or more compute units each configured to launch one or more wavefronts (e.g., waves) to perform a workgroup. To this end, each compute unit includes one or more single instruction, multiple data (SIMD) units each including a plurality of lanes configured, for example, to perform a same operation on different data sets as indicated in one or instructions received from an application 110. As an example, each SIMD unit includes a plurality of arithmetic logic units (ALUs) that each perform a same operation on a plurality of data sets. In embodiments, one or more SIMD units of a compute unit include a vector SIMD unit (e.g., a SIMD unit including one or more vector ALUs), a scalar SIMD unit (e.g., a SIMD unit including one or more scalar ALUs), or both. According to embodiments, each compute unit is configured to concurrently launch one or more waves. For example, one or more lanes of each SIMD unit of a compute unit are configured to concurrently perform the operations for one or more waves. Each portion (e.g., lanes) of a SIMD unit configured to perform operations for a wave is also referred to herein, for example, as a waveslot. In this way, a compute unit has a number of waveslots (e.g., portions of SIMD units) each configured to concurrently perform one or more waves (e.g., perform operations for one or more waves).

Further, to support the SIMD units, each processor core 116 includes or is otherwise coupled to one or more respective sets of compute unit resources 122. For example, each compute unit of a processor core 116 includes or is otherwise coupled to a respective set of compute unit resources 122. These compute unit resources 122, for example, are configured to store values, register files, operands, instructions, variables, result data (e.g., data resulting from the performance of one or more operations), flags, or any combination thereof necessary for, aiding in, or helpful for performing one or more operations indicated in one or more instructions from an application 110 (e.g., in a workgroup based on the instructions from an application 110). Further, such compute unit resources 122 include, for example, one or more registers (e.g., vector registers, scalar registers), local data shares, scratch memory, or any combination thereof. According to embodiments, one or more compute unit resources 122 are included in a respective compute unit, one or more compute unit resources 122 are shared between two or more compute units, or both. Though the example embodiment illustrated in FIG. 1 presents processing system 100 with three sets of compute unit resources (122-1, 122-2, 122-N) for three respective processor cores 116, in other embodiments, processing system 100 may have any number of sets of compute unit resources 122 for one or more respective processor cores 116.

In embodiments, processing system 100 is configured to allocate one or more portions of one or more compute unit resources 122 (e.g., registers, local data shares, scratch memory) to one or more waves of a workgroup (e.g., portions of the SIMD units of one or more compute units performing the operations for the waves). To this end, in embodiments, APU 114 includes a command processor (not shown for clarity) including hardware-based circuitry, software-based circuitry, or both configured to issue respective workgroups (e.g., as commands, instructions, or both) to one or more compute units of one or more processor cores 116. In response to the workgroups being issued to one or more compute units, fixed-function hardware (e.g., software-based circuitry, hardware-based circuitry or both configured to implement graphics pipeline stages, tessellation stages, rasterization stages, or any combination thereof) of APU 114 allocates one or more portions of one or more compute unit resources 122 to the waves of the workgroups to be launched on the compute units (e.g., to the lanes of the SIMD units to perform operations for the waves) based on the types of operations identified in the workloads, the availability of compute unit resources 122, priorities associated with the workloads, or any combination thereof. For example, fixed-function hardware of APU 114 (e.g., via a serial peripheral interface (SPI)) programs a base register with a base address to allocate one or more physical registers (e.g., vector registers, scalar registers) of a set of compute unit resources 122 to one or more waves to be launched on a compute unit. In response to receiving an instruction to launch a wave, a compute unit of a processor core 116 determines the physical registers (e.g., vector registers, scalar registers) of a set of compute unit resources 122 allocated to the waves to be launched based on the base address in the base register. However, allocating compute unit resources 122 to the waves using the fixed-function hardware of APU 114 limits the flexibility in the allocation of compute unit resources 122 to different waves, SIMD units, or both. For example, operations for some applications (e.g., shader programs) require fewer compute unit resources 122 than are allocated by the fixed-function hardware of APU 114. As another example, the number of compute unit resources 122 necessary for performing operations for some application change as the operations (e.g., workgroup) is being performed. As such, the fixed-function hardware of APU 114 allocates more compute unit resources 122 to a wave, SIMD, or both than are necessary to or helpful for performing these operations. In this way, processing system 100 limits the number of compute unit resources 122 available for allocation, which reduces the number of concurrent waves a compute unit launches and reduces the processing efficiency of processing system 100.

To help increase the number of concurrent waves on a compute unit and increase the processing efficiency of processing system 100, processing system 100 is configured to allocate one or more portions of one or more compute unit resources 122 (e.g., set of registers, local data shares, scratch memory) to one or more waves based on program code 108 (e.g., shader code, raytracing code) from one or more applications 110 (e.g., shader programs, raytracing programs). For example, in embodiments, program code 108 includes data identifying a workgroup that includes a plurality of waves and data identifying resource allocations for one or more waves of the workgroup. Such resource allocations for a wave include, for example, data identifying one or more registers allocated to a respective wave, an amount (e.g., in kilobytes) of a local data share allocated to a respective wave, one or more barriers of a respective wave, one or more other waves to be synchronized with a respective wave (e.g., one or more waves to be run concurrently with a respective wave), or any combination thereof. Such barriers include one or more thread barriers (e.g., thread synchronization points) for a respective wave that, for example, cause one or more threads of a wave to pause until each thread of the wave has performed a predetermined operation, function, or both indicated by the barrier. Based on receiving data (e.g., as commands, instructions, or both) indicating the workgroups, resource allocations, synchronization data, or any combination thereof of program code 108, APU 114 allocates at least a portion of a set of compute unit resources 122 to one or more waves indicated in the program code 108 based on the resource allocations indicated in the program code 108. For example, in response to receiving data indicating the workgroups, resource allocations, and synchronization data of program code 108, APU 114 edits one or more hardware registers of APU 114 based on one or more resource allocations indicated in program code 108. In some embodiments, the data identifying a workgroup, resource allocation, or synchronization data of program code 108 is provided to APU 114 via a command or an instruction (e.g., an instruction identifying the workgroup and resource allocations). For example, in some embodiments, APU 114 receives an instruction identifying a workgroup, resource allocations, and synchronization data, and based on the instruction, allocates at least a portion of a set of compute unit resources 122 to one or more waves of the workgroup.

Assigning compute unit resources 122 to waves in this way allows more flexibility in the allocation of resources. For example, only the amount of compute unit resources 122 necessary for performing one or more operations of a wave are allocated to a wave. Additionally, the APU 114 is able to dynamically allocate compute unit resources 122 when a workgroup is assigned to or received by APU 114. That is to say, APU 114 is configured to dynamically allocate respective compute unit resources 122 to each workgroup received by APU 114 such that, for example, a first workgroup received by APU 114 is allocated a first set of compute unit resources 122 having a first number of compute unit resources and a second workgroup received by APU 114 is allocated a second set of compute unit resources 122 have a second number of compute unit resources, different from the first number of compute unit resources 122. Further, assigning compute unit resources 122 in this way allows APU 114 to allocate compute unit resources 122 while a workgroup, wave, or both are being processed (e.g., operations for the workgroup or wave are being performed). For example, while performing a workgroup, APU 114 receives one or more instructions identifying a second set of compute unit resources 122 to allocate to the workgroup. As such, APU 114 is able to to change compute unit resource 122 allocations as the number of compute unit resources 122 necessary for performing a workgroup, wave, or both changes while the workgroup is performed. In this way, the processing efficiency of processing system 100 is increased as the number of excess processing resources assigned to waves is reduced, allowing for additional concurrent waves to be launched on a compute unit. Additionally, for example, specifying which waves are to launch concurrently allows processing system 100 to further increase the efficiency of the allocation of compute unit resources 122 by grouping together such waves based on the availability of compute unit resources 122 (e.g., grouping together waves to maximize the number of concurrent waves launched by a compute unit). Further, in embodiments, program code 108 includes data indicating that two or more waves are to be allocated a same processing resource (e.g., vector register, scalar register, LDS) of a set of compute unit resources 122. That is to say, program code 108 includes data indicating that one or more compute unit resources 122 are to be shared across two or more waves. As such, sharing compute unit resources 122 between two or more waves increases the amount of compute unit resources 122 available to the workgroup as a whole, increasing the number of concurrent waves launched by a compute unit and increasing the processing efficiency of processing system 100.

The processing system 100 also includes a central processing unit (CPU) 102 that is connected to the bus 112 and therefore communicates with the APU 114 and the memory 106 via the bus 112. The CPU 102 implements a plurality of processor cores 104-1 to 104-N that execute instructions concurrently or in parallel. In embodiments, one or more of the processor cores 104 each operate as one or more compute units (e.g., SIMD units) that perform the same operation on different data sets. Though in the example embodiment illustrated in FIG. 1, three processor cores (104-1, 104-2, 104-M) are presented representing an M number of cores, the number of processor cores 104 implemented in the CPU 102 is a matter of design choice. As such, in other embodiments, the CPU 102 can include any number of processor cores 104. In some embodiments, the CPU 102 and APU 114 have an equal number of processor cores 104, 116 while in other embodiments, the CPU 102 and APU 114 have a different number of processor cores 104, 116. The processor cores 104 execute instructions such as program code 108 stored in the memory 106 and the CPU 102 stores information in the memory 106 such as the results of the executed instructions. The CPU 102 is also able to initiate graphics processing by issuing draw calls to the APU 114. In embodiments, the CPU 102 implements multiple processor cores (not shown in FIG. 1 in the interest of clarity) that execute instructions concurrently or in parallel.

An input/output (I/O) engine 118 includes hardware and software to handle input or output operations associated with the display 120, as well as other elements of the processing system 100 such as keyboards, mice, printers, external disks, and the like. The I/O engine 118 is coupled to the bus 112 so that the I/O engine 118 communicates with the memory 106, the APU 114, or the CPU 102.

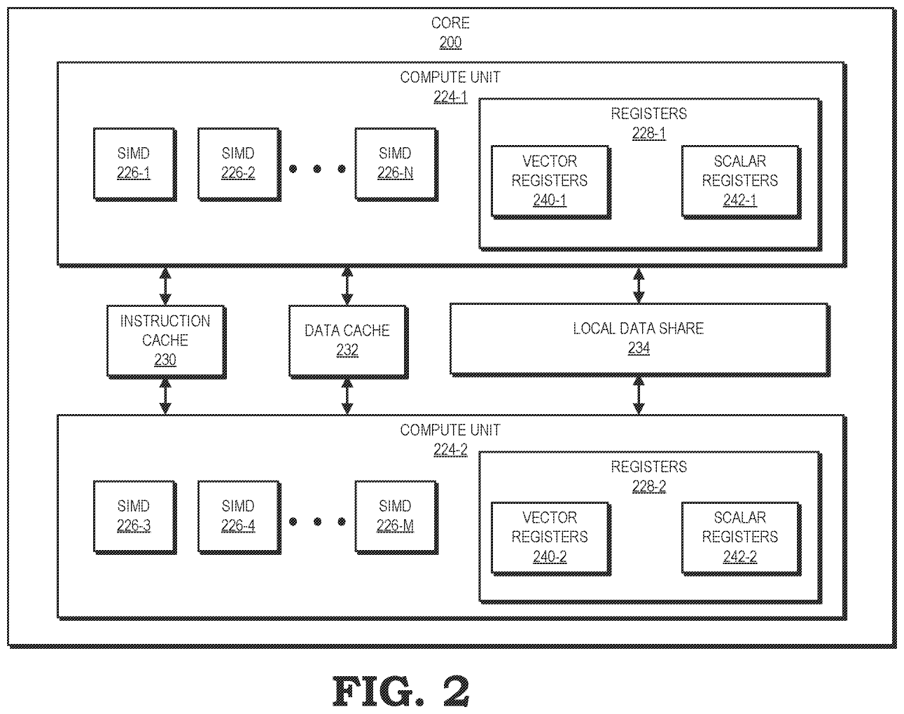

Referring now to FIG. 2, an example processor core 200 configured for software-defined compute unit resource allocation is presented. In embodiments, processor core 200, similar to or the same as processor cores 116, includes two compute units 224 configured to perform one or more workgroups (e.g., group of work items) indicated in program code 108 from an application 110 (e.g., shader program, raytracing program). Though the example embodiment of FIG. 2 presents processor core 200 having two compute units (224-1, 224-2), in other embodiments, processor core 200 may have any number of compute units 224. To perform a workgroup indicated in program code 108, each compute unit 224 is configured to launch one or more waves (e.g., wavefronts) to perform one or more functions, operations, or both indicated in the workgroup (e.g., indicated in the program code 108). To this end, each compute unit 224 includes one or more SIMD units 226 (e.g., vector SIMD units, vector SIMD units) each configured to perform one or more operations for one or more functions identified in a workgroup in one or more waves. That is to say, at least a portion of each SIMD unit 226 is configured to launch a wave using one or more lanes of the SIMD unit 226 to perform one or more operations for one or more functions identified in a workgroup. Though the example embodiment of FIG. 2 presents compute unit 224-1 having three SIMD units (226-1, 226-2, 226-N) representing an N number of SIMD units and compute unit 224-2 having three SIMD units (226-3, 226-4, 226-M) representing an M number of SIMD units, in other embodiments, each compute unit 224 may include any number of SIMD units 226.

To aid SIMD units 226 in performing one or more operations for a workgroup, each compute unit 224 includes or is otherwise connected to instruction cache 230. For example, in embodiments, each compute unit 224-1, 224-2 includes a respective instruction cache 230 while in other embodiments, one or more instruction caches 230 are connected to each compute unit 224-1, 224-2 (e.g., are shared by the compute units 224). Instruction cache 230, for example, includes a memory (e.g., SRAM) configured to store one or more instructions necessary for, aiding in, or helpful for performing one or more operations of a workgroup (e.g., one or more operations for the waves of a workgroup). In embodiments, instruction cache 230 is shared by each wave (e.g., lanes of the SIMD units performing operations for the wave) launched by one or more compute units. For example, instruction cache 230 is shared by the waves launched on compute units 224-1, 224-2. Similarly, each compute unit 224 also includes or is otherwise connected to data cache 232. For example, in embodiments, each compute unit 224-1, 224-2 includes a respective data cache 232 while in other embodiments, one or more data caches 232 are connected to each compute unit 224-1, 224-2 (e.g., are shared by the compute units 224). Data cache 232, for example, includes a memory (e.g., SRAM) configured to store data (e.g., cache lines) necessary for, aiding in, or helpful for performing one or more operations of a workgroup (e.g., one or more operations for the waves of a workgroup). In embodiments, instruction cache 230 is shared by each wave (e.g., lanes of the SIMD units performing operations for the wave) launched by one or more compute units.

Additionally, to aid SIMD units 226 in performing one or more operations for a workgroup, processor core 200 includes or is otherwise connected to a set of compute unit resources, similar to or the same as a set of compute unit resources 122, configured to, for example, store values, register files, operands, instructions, variables, result data (e.g., data resulting from the performance of one or more operations), flags, or any combination thereof necessary for, aiding in, or helpful for performing one or more operations indicated in a workgroup received by the processor core 200. Such processing resources, for example, include registers 228, local data share 234, or both. For example, each compute unit 224 includes or is otherwise connected to a set of registers 228 configured to store values, operands, resulting data (e.g., data resulting from the performance of one or more operations, register files, or any combination thereof) necessary for, aiding in, or helpful for the performance of one or more operations for a workgroup. In embodiments, a set of registers 228 includes one or more vector registers 240 configured to store data (e.g., operands, values) necessary for, aiding in, or helpful for the performance of one or more operations by, for example, a vector SIMD unit 226. Such vector registers 240, for example, are shared by one or more lanes of a SIMD unit 226 performing operations for one or more waves of a workgroup. According to embodiments, one or more vector registers 240 are allocated to one or more lanes of a SIMD unit 226 performing operations for a same wave, one or more vector registers are allocated to one or more lanes of a SIMD unit 226 performing operation for two or more waves (e.g., one or more vector registers are allocated such that the vector registers are shared by the lanes of a SIMD unit 226 performing operations for two or more waves), or both. A set of registers 228, in embodiments, additionally or alternatively includes one or more scalar registers 242 configured to store data (e.g., operands, values) necessary for, aiding in, or helpful for the performance of one or more operations by, for example, a scalar SIMD unit 226. Though the example embodiment presented in FIG. 2 provides a first compute unit 224-1 having one set of registers 228-1 (e.g., including vector registers 240-1 and scalar registers 242-1) and a second compute unit having one set of registers 228-2 (e.g., including vector registers 240-2 and scalar registers 242-2), in other embodiments, each compute unit 224 may have any number of sets of registers 228 each including any number of vector registers 240, scalar registers 242, or both.

Further, each compute unit 224 includes or is otherwise connected to local data share 234. Local data share 234 includes a memory (e.g., SRAM) shared across each SIMD unit 226 across one or more compute units. That is to say, local data share 234 is shared across each wave executing on one or more compute units 224. For example, in the example embodiment presented in FIG. 2, local data share 234 is shared across each SIMD unit 226 of compute unit 224-1 and compute unit 224-2 such that local data share 234 is shared across the waves launched on compute unit 224-1 and compute unit 224-2. In embodiments, local data share 234 is configured to store results (e.g., data resulting from the performance of one or more operations by one or more SIMD units 226), operands, register files, or any combination thereof necessary for, aiding in, or helpful for the performance of one or more operations by one or more SIMD units 226. As an example, local data share 234 is used as a scratch memory to store results necessary for, aiding in, or helpful for the performance of one or more operations by one or more SIMD units 226. Additionally, because local data share 234 is shared across each SIMD unit 226 and one or more compute units (e.g., shared across the waves executing on one or more compute units 224), local data share 234 allows for data to be shared across the SIMD units 226 of one or more compute units 224 (e.g., across the waves executing on the compute units 224). For example, results determined from the performance of an operation for a first wave by, for example, one or more lanes of a SIMD unit 226, are stored in local data share 234. Such results are then made available to one or more operations of one or more other waves executed on, for example, one or more other lanes of a same or different SIMD unit 226. According to embodiments, processing system 100 is configured to allocate at least a portion of local data share 234 to one or more waves of a workgroup to be performed on one or more compute units 224. For example, processing system 100 defines one or more respective portions (e.g., in kilobytes) of local data share 234 that are to be visible to one or more waves of a workgroup to be performed on one or more compute units 224 (e.g., visible to one or more lanes of one or more SIMD units 226 configured to perform one or more waves of a workgroup).

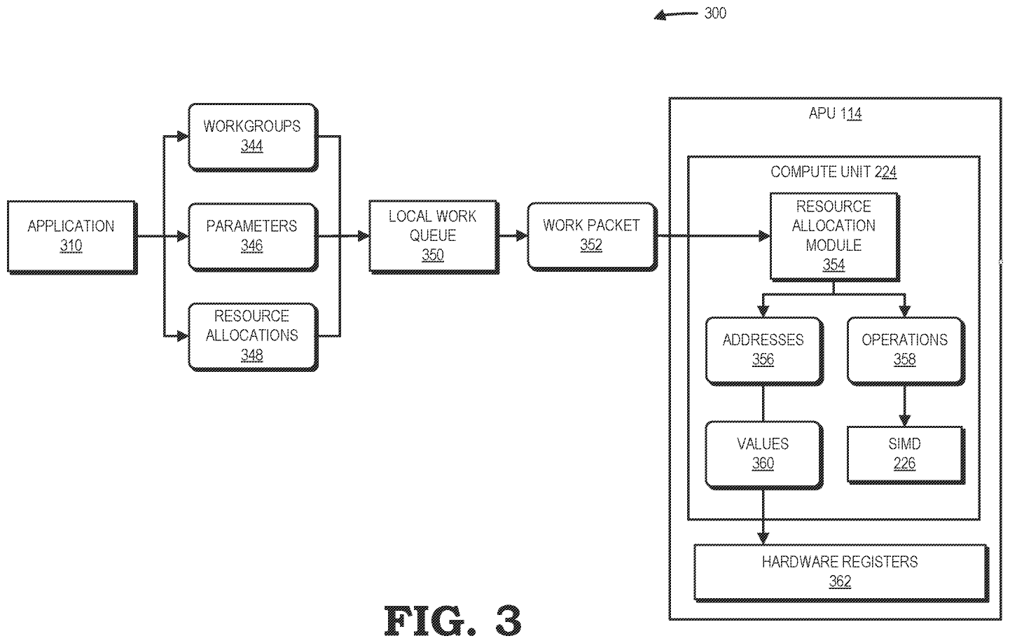

Referring now to FIG. 3, an example operation 300 for software-defined allocations of compute unit resources is presented. In embodiments, example operation 300 includes processing system 100 executing an application 310, similar to or the same as application 110. Application 310, for example, includes a shader program, raytracing program, machine-learning program, or any combination thereof running on processing system 100. In embodiments, application 310 includes generating program code, similar to or the same as program code 108, that includes one or more instructions to be performed by APU 114. For example, the program code includes one or more work items (e.g., functions) to be performed by APU 114. According to embodiments, application 310 is configured to group one or more work items of the program code into one or more workgroups 344 based on, for example, the available compute unit resources of APU 114, the types of functions, operations, or both indicated in the work items, priorities of the work-items, or any combination thereof. For example, application 310 is configured to group work items together based on the available compute unit resources of APU 114 such that one or more resulting workgroups 344 include a predetermined number of waves, a number of waves based on a maximum number of currently available waveslots on one or more compute units, a number of waves based on the maximum number of waveslots associated with one or more compute units, or any combination thereof. Further, application 310 is configured to define synchronization data for workgroups 344 in the program code. Such synchronization data includes, for example, one or more respective thread barriers (e.g., thread synchronization points) for one or more waves of a workgroup, workgroup groupings, or both. Such workgroup groupings, for example, include data indicating one or more waves of one or more workgroups 344 to be concurrently performed. For example, workgroup groupings include data indicating that a first wave of a first workgroup 344 is to be concurrently performing with a second wave of the first workgroup 344, a second workgroup 344, or both.

In embodiments, application 310 is further configured to determine one or more respective parameters 346 for the workgroups 344 in the program code. Such parameters 346 include, for example, one or more values, instructions, operands, register files, results (e.g., data resulting from the performance of one or more operations), or any combination thereof necessary for, aiding in, or helpful for the performance of a workgroup 344 (e.g., the work items of the workgroup 344). Additionally, application 310 is configured to define one or more respective resource allocations 348 for one or more workgroups 344 in the program code. Such resource allocations 348, for example, include data allocating one or more portions of one or more allocatable resources (e.g., vector registers 240, scalar registers 242, local data share 234) to one or more waves of a workgroup 344. As an example, such resource allocations 348 include data indicating respective numbers of vector registers 240 and a respective amount of data in local data share 234 to be allocated to the waves of a workgroup 344. In embodiments, resource allocations 348 include data indicating one or more allocated resources are to be shared between two or more waves of a workgroup 344 (e.g., shared between two or more waveslots of a compute unit). For example, resource allocations 348 include data indicating two vector registers 240 are to be allocated to a first wave of a workgroup 344 and that the same two vector registers 240 are also to be allocated (e.g., are to be shared) with a second wave of workgroup 344.

According to embodiments, one or more workgroups 344, parameters 346, resource allocations 348, or any combination thereof in the program code of application 310 are stored in local work queue 350. For example, data indicating one or more workgroups 344, parameters 346, resource allocations 348, or any combination thereof is stored in local worked queue 350 as one or more commands, instructions, or both. Local work queue 350 includes, for example, one or more hardware queues, software queues, or both communicatively coupled to one or more compute units of APU 114. In embodiments, local work queue 350 is configured to store workgroups 344, parameters 346, resource allocations 348, or any combination thereof as one or more work packets 352. These work packets 352, for example, include data (e.g., commands, instructions) identifying a workgroup 344, one or more parameters 346 associated with (e.g., necessary for, aiding in, or helpful for the performance of) the workgroup 344, one or more resource allocations 348 associated with (e.g., defining resources to be allocated to waves of) the workgroup 344, or any combination thereof. For example, a work packet 352 includes a workgroup 344 including instructions that identify one or more waves to be launched, parameters 346 (e.g., values, instructions, operands, register files, results) necessary for performing the waves, and resource allocations 348 defining a number of vector registers 240 to be assigned for each wave and a number of vector registers 240 to be shared between two or more waves. According to embodiments, a compute unit 224 of APU 114 is configured to request one or more work packets 352 from local work queue 350. For example, in response to a compute unit 224 having one or more free waveslots (e.g., waveslots not performing operations for a wave), a compute unit 224 not currently being assigned to a workgroup 344, a compute unit 224 completing a wave, a compute unit 224 completing a workgroup 344 (e.g., completing a previous workgroup), or any combination thereof, compute unit 224 is configured to request (e.g., take) a work packet 352 from local work queue 350.

To this end, the compute unit 224 includes resource allocation module 354 that includes hardware-based circuitry, software-based circuitry, or both configured to receive (e.g., take) a work packet 352 from local work queue 350. In response to receiving work packet 352, resource allocation module 354 is configured to assign one or more waves of the workgroup 344 indicated in the work packet 352 to one or more respective waveslots of compute unit 224. For example, resource allocation module 354 is configured to assign the waves of a workgroup 344 to respective waveslots based on the allocatable resources to be shared between waves, the synchronization data of the waves (e.g., data indicating two or more waves to be launched concurrently), data (e.g., results, operands) shared between two or more waves, or any combination thereof. As another example, resource allocation module 354 is configured to assign the waves of a workgroup 344 to respective waveslots based on one or more instructions associated of the workgroup 344 indicating the allocatable resources to be shared between waves, the synchronization data of the waves (e.g., data indicating two or more waves to be launched concurrently), data (e.g., results, operands) shared between two or more waves, or any combination thereof. Additionally, resource allocation module 354 is further configured to allocate portions of one or more allocatable resources (e.g., vector registers 240, scalar registers 242, local data share 234) associated with the compute unit 224 to each waveslot (e.g., portions of SIMD units 226) of the compute unit 224. For example, based on the respective resource allocations 348 for each wave of the workgroup 344 indicated in the work packet 352, resource allocation module 354 is configured to allocate portions of the allocatable resources. To allocate such allocatable resources, resource allocation module 354 is configured to determine one or more addresses 356, values 360, or both used to update hardware registers 362 of APU 114. Such hardware registers 362, for example, include hardware-based circuitry configured to define the base addresses of one or more allocatable resources (e.g., vector registers 240, scalar register 242, local data share 234) such that the allocatable resources are allocated to one or more waves of a workgroup 344 (e.g., waveslots of one or more compute units 224). According to embodiments, resource allocation module 354 determines one or more addresses 356, values 360, or both necessary for updating hardware registers 362 such that allocatable resources of a compute unit 224 are allocated to one or more waves of a workgroup 344 (e.g., waveslots of one or more compute units 224) based on the respective resource allocations 348 for each wave of the workgroup 344 indicated in the work packet 352. As an example, resource allocation module 354 determines one or more base addresses and values necessary for allocating vector registers 240 and a portion of local data share 234 of a compute unit 224 to one or more waves of a workgroup 344 (e.g., one or more waveslots of one or more compute units 224) based on the respective resource allocations 348 for each wave of the workgroup 344 indicated in the work packet 352.

After updating hardware registers 362 to allocate the allocatable resources to one or more waveslots of the compute unit 224, the compute unit 224 is configured to launch one or more waves of the workgroup 344 indicated in the work packet 352 such that one or more SIMDs perform operations 358 for the waves. In embodiments, compute unit 224 (e.g., SIMD units 226) is configured to perform the waves based on synchronization data indicated in the work packet 352. For example, compute unit 224 is configured to launch two or more wave concurrently based on synchronization data indicated in the work packet 352. As another example, compute unit 224 is configured to pause, resume, or both the performance of one or more waves based on one or more barriers (e.g., thread barriers) indicated in the synchronization data of the work packet. According to embodiments, resource allocation module 354 is further configured to allocate the allocatable resources to one or more waveslots of a workgroup, while a compute unit is performing the workgroup. As an example, while a workgroup is being performing by a compute unit using a first set of allocatable resources, resource allocation module 354 is configured to allocate a second set of allocatable resources, different from the first set of allocatable resources, based on one or more received instructions (e.g., one or more instructions in a work packet 352 associated with the workgroup) identifying the workgroup.

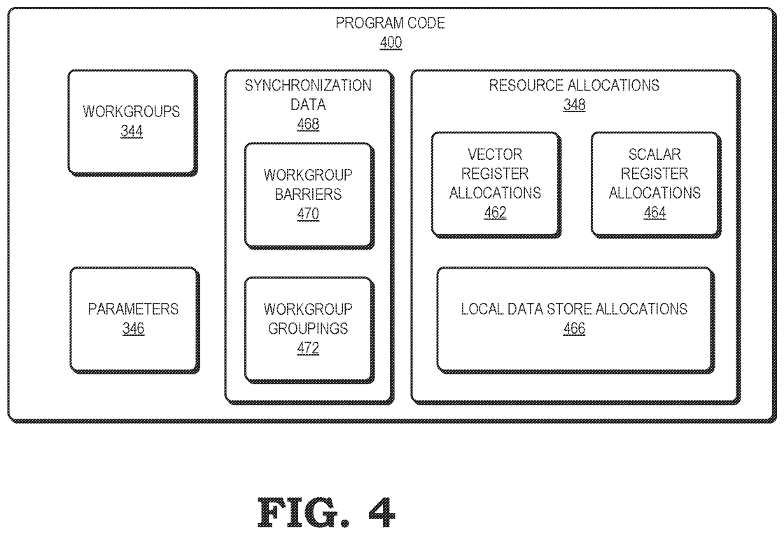

Referring now to FIG. 4, an example program code 400 for software-defined compute unit resource allocation is presented. In embodiments, program code 400 is generated by an application, similar to or the same as applications 110, 310, which includes, for example, a shader program, raytracing program, machine-learning program, or any combination thereof. Program code 400 includes data, for example, indicating workgroups 344, parameters 346, resource allocations 348, and synchronization data 468. Workgroups 344, for example, one or more work items grouped together based on the available allocatable resources of APU 114, the types of functions, operations, or both indicated in the work items, priorities of the work items, or any combination thereof and parameters 346 includes one or more respective values, instructions, operands, register files, results (e.g., data resulting from the performance of one or more operations), or any combination thereof necessary for, aiding in, or helpful for the performance of a workgroup 344 (e.g., the work items of the workgroup 344).

For each workgroup of workgroups 344, program code 400 includes respective resource allocations 348. Such resource allocations 348 include, for example, vector register allocations 462, scalar register allocations 464, and local data share allocations 466. Vector register allocations 462, for example, include data indicating a respective number of vector register 240 to allocate to each wave of a workgroup 344, a respective number of vector registers 240 to share between two or more waves of a workgroup 344, or both. As an example, vector register allocations 462 include data indicating a first number of vector registers 240 to allocate to a first wave of a workgroup 344, a second number of vector registers 240 to allocate to a second wave of the workgroup 344, and a number of vector register 240 that are to be shared between the first and second waves. Similarly, scalar registers allocations 464, for example, include data indicating a respective number of scalar registers 242 to allocate to each wave of a workgroup 344, a respective number of scalar registers 242 to share between two or more waves of a workgroup 344, or both. In embodiments, resource allocations 348 include local data share allocations 466. Local data share allocations 466 include, for example, data indicating a respective amount of local data share 234 to allocate (e.g., make visible) to each wave of a workgroup 344, a respective amount of local data share 234 to share between two or more waves of a workgroup 344, or both. As an example, local data share allocations 466 include data indicating a first amount (e.g., in KBs) of local data share 234 to allocate (e.g., make visible) to a first wave of a workgroup 344, a second amount of local data share 234 to allocate to a second wave of the workgroup 344, and an amount of local data share 234 that is to be shared between the first and second waves.

According to embodiments, program code 400 further includes synchronization data 468 including, for example, workgroup barriers 470, workgroup groupings 472, or both. Workgroup barriers 470 include data defining one or more respective thread barriers (e.g., thread synchronization points) for one or more waves of a workgroup 344. Such thread barriers, for example, include data that identifies one or more operations, functions, or both of a wave. Based on the identified operation, function, or both, one or more threads (e.g., lanes of a SIMD unit 226) of a wave pause after completing the identified operation or function and resume operation when each thread of the wave has performed the identified operation or function. In this way, the threads of the wave are synchronized based on the thread barrier. Workgroup groupings 472, for example, include data indicating two or more workgroups 344 to be performed concurrently, two or more waves of a workgroup 344 to be performed concurrently, two or more waves or two or more workgroups 344 to be performed concurrently, or any combination thereof. Based on such workgroup groupings 472, one or more compute units 224 are configured to launch waves such that the workgroups 344, waves, or both identified in workgroup groupings 472 are performed concurrently.

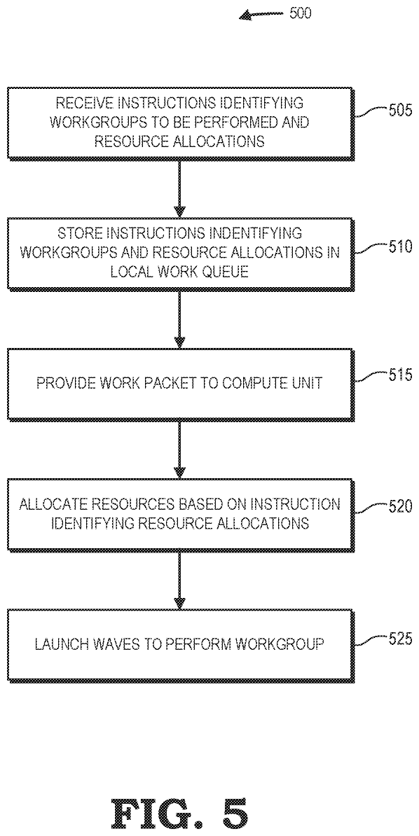

Referring now to FIG. 5, an example method 500 for performing software-defined processing resource allocations is presented. At step 505 of method 500, an APU, similar to or the same as APU 114, receives program code (e.g., shader code, raytracing code), similar to or the same as program code 108, from one or more applications (e.g., shader programs, raytracing programs), similar to or the same as applications 110. Such program code, for example, includes data identifying one or more workgroups (e.g., groups of work items), similar to or the same as workgroups 344, to be performed by the APU and one or more resource allocations, similar to or the same as resource allocations 348, for performing the workgroups 344. For example, the program code includes data identifying a workgroup having a first number of waves and resources allocations indicating a number of vector registers (e.g., vector registers 240) to allocate to each wave of the workgroup, a number of vector registers to share between two or more waves of the workgroup, or both. In embodiments, the APU receives the program code, data identifying one or more workgroups, resource allocations, or both as one or more commands, instructions, or both (e.g., instructions identifying one or more workgroups, resource allocations, or both). At step 510, the APU stores the workgroups and resources (e.g., instructions identifying the workgroups and resources) in a local work queue similar to or the same as local work queue 350. In embodiments, the local work queue is configured to store a workgroup and associated resource allocations (e.g., resource allocations for the waves of the workgroup) as a work packet, similar to or the same as work packet 352. At step 515, the APU requests (e.g., takes) one or more work packets identifying a workgroup and one or more resource allocations from the local work queue. For example, in response to one or more compute units of the APU completing the performance of one or more workloads (e.g., completing a previous workgroup), completing one or more waves of one or more workloads, having one or more available (e.g., empty) waveslots, or any combination thereof, the APU requests (e.g., takes) one or more work packets from the local work queue.

At step 520, the APU allocates resources to the waveslots (e.g., lanes of one or more SIMD units) of one or more compute units, similar to or the same as compute units 224, based on the received work packet (e.g., one or more instructions of the work packet). For example, based on the resource allocations identified in the work packet (e.g., identified in one or more instructions), the APU allocates resources to the waveslots of one or more compute units. As another example, based on the resource allocations identified in a second instruction of the work packet, the APU allocates resources to one or more waveslots of a compute unit while the compute unit is processing (e.g., performing operations for) one or more workgroups. To allocate such resources, the APU is configured to edit one or more hardware registers, similar to or the same as hardware registers 362, of the APU. For example, the APU determines one or more addresses (e.g., addresses 356, base addresses), values (e.g., values 360), or both necessary for allocating resources to the waveslots of one or more compute units based on the resource allocations identified in a work packet. After determining one or more addresses, values, or both, the APU updates one or more addresses in the hardware registers based on the determined addresses to allocate resources to the waveslots of the compute units. At step 525, in response to updating the hardware registers, the APU performs a workgroup identified in the work packet by launching one or more waves of the workgroup on one or more compute units.

In some embodiments, the apparatus and techniques described above are implemented in a system including one or more integrated circuit (IC) devices (also referred to as integrated circuit packages or microchips), such as the processing system configured for software-defined resource allocation described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving, from an application, an instruction identifying a workgroup including a plurality of waves and identifying resource allocations for the plurality of waves, allocating a set of processing resources to a compute unit based on the resource allocations for the plurality of waves; and
performing the workgroup using the set of processing resources allocated to the compute unit.

2. The method of claim 1, further comprising:
storing, in a local work queue, the instruction identifying the workgroup and the resource allocations for the plurality of waves.

3. The method of claim 2, further comprising:
in response to the compute unit performing a previous workgroup, requesting, from the local work queue, data including the instruction identifying the workgroup and the resource allocations for the plurality of waves.

4. The method of claim 1, further comprising:
while the workgroup is being performed, allocating a second set of processing resources to the workgroup based on a second instruction identifying the workgroup.

5. The method of claim 1, wherein allocating the set of processing resources to the compute unit comprises:
allocating a same processing resource to two or more waveslots of the compute unit based on the resource allocations for the plurality of waves.

6. The method of claim 1, further comprising:
performing the plurality of waves of the workgroup based on synchronization data received from application.

7. The method of claim 6, wherein the synchronization data identifies a thread barrier for a wave of the plurality of waves.

8. The method of claim 6, wherein the synchronization data identifies two or more waves of the plurality of waves to be performed concurrently.

9. The method of claim 1, wherein the resource allocations for the plurality of waves identify a respective number of vector registers for each wave of the plurality of waves.

10. The method of claim 1, further comprising:
modifying a hardware register based on the resource allocations for the plurality of waves.

11. A processing system, comprising:
a memory; and
a processor coupled to the memory and configured to receive, from an application, an instruction identifying a workgroup including a plurality of waves and identifying resource allocations for the plurality of waves, wherein the processor comprises:
a plurality of compute units, wherein at least on compute unit of the plurality of compute units comprises:
a resource allocation module configured to allocate a set of processing resources to the at least one compute unit based on the resource allocations for the plurality of waves; and
a plurality of waveslots configured to perform the workgroup using the set of processing resources allocated to the compute unit.

12. The processing system of claim 11, further comprising:
a local work queue configured to store the instruction identifying the workgroup and the resource allocations for the plurality of waves.

13. The processing system of claim 12, wherein the at least one compute unit is configured to:
in response to at least one compute unit performing a previous workgroup, request, from the local work queue, data including the instruction identifying the workgroup and the resource allocations for the plurality of waves.

14. The processing system of claim 11, wherein the resource allocation module is configured to:
while performing the workgroup, allocate a second set of processing resources to one or more waveslots based on a second instruction identifying the workgroup.

15. The processing system of claim 11, wherein the resource allocation module is configured to:
allocate a same processing resource to two or more waveslots of the plurality of waveslots based on the resource allocations for the plurality of waves.

16. The processing system of claim 11, the processor configured to:
receive, from the application, data identifying a respective thread barrier for one or more waves of the plurality of waves.

17. The processing system of claim 11, wherein the processor further comprises a hardware register and wherein the resource allocation module configured to allocate the set of processing resources by modifying the hardware register based on the resource allocations for the plurality of waves.

18. The processing system of claim 11, wherein the resource allocations for the plurality of waves identify a respective amount of a local data share for each wave of the plurality of waves.

19. A processor comprising:
one or more processing cores configured to:
in response to receiving, from an application, synchronization data for a plurality of waves and an instruction identifying resource allocations for the plurality of waves, allocate a set of processing resources to a compute unit based on the resource allocations for the plurality of waves; and
perform the plurality of waves using the set of processing resources allocated to the compute unit and based on the synchronization data.

20. The processor of claim 19, wherein the synchronization data identifies a thread barrier for a wave of the plurality of waves.

21. The processor of claim 19, wherein the synchronization data identifies two or more waves of the plurality of waves to be performed concurrently.

22. The processor of claim 19, wherein the one or more processor cores are configured to:
while performing the plurality of waves, allocate a second set of processing resources to the compute unit based on a second instruction.
